(19) United States
(12) Patent Application Publication
(10) Pub. No.: US 2024/0122250 A1
(43) Pub. Date: Apr. 18, 2024

(54) APPARATUS FOR HEATING AEROSOLISABLE MATERIAL

(71) Applicant: NICOVENTURES TRADING LIMITED, London (GB)

(72) Inventors: Luke WARREN, London Greater London (GB); Matthew HODGSON, London Greater London (GB); Anton KORUS, Derby Derbyshire (GB)

(21) Appl. No.: 18/263,935

(22) PCT Filed: Feb. 7, 2022
(86) PCT No.: PCT/EP2022/052906

§ 371 Date: Aug. 2, 2023

(30) Foreign Application Priority Data
Feb. 10, 2021 (GB) 2101851.0

(51) Int. Cl. A24F 40/465; A24F 40/20; H05B 6/10

(52) U.S. Cl. CPC A24F 40/465; A24F 40/20; H05B 6/105

(57) ABSTRACT

An apparatus for heating aerosolizable material to volatize at least one component of the aerosolizable material is described. The apparatus includes a heating zone for receiving at least a portion of an article including aerosolizable material. The apparatus also includes a heating assembly having a magnetic field generator and a heating element. The magnetic field generator includes an inductor coil configured to generate a varying magnetic field. The heating element includes a base portion that is heatable by penetration with the varying magnetic field and a heating portion protruding from the base portion to heat the heating zone. The heating portion is heatable by the base portion by thermal conduction and the thermal conductivity of the heating portion is greater than the thermal conductivity of at least part of the base portion.

### PRIORITY CLAIM

The present application is a National Phase entry of PCT Application No. PCT/EP2022/052906, filed Feb. 7, 2022, which claims priority from GB Application No. 2101851.0, filed Feb. 10, 2021, each of which is hereby fully incorporated herein by reference.

### TECHNICAL FIELD

The present disclosure relates to an apparatus for heating aerosolizable material to volatize at least one component of the aerosolizable material. The present disclosure also relates to an elongate heating element for use in apparatus for heating aerosolizable material, an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an apparatus for heating aerosolizable material to volatize at least one component of the aerosolizable material, the apparatus comprising: a heating zone for receiving at least a portion of an article comprising aerosolizable material; a heating assembly comprising: a magnetic field generator including an inductor coil configured to generate a varying magnetic field; a heating element comprising a base portion that is heatable by penetration with the varying magnetic field and a heating portion protruding from the base portion to heat the heating zone, wherein the heating portion is heatable by the base portion by thermal conduction; and wherein the thermal conductivity of the heating portion is greater than the thermal conductivity of at least part of the base portion.

The inductor coil may be at least one of a planar coil and a spiral coil.

The spiral coil may be a flat spiral coil.

The spiral coil may be non-planar.

The inductor coil may comprise a thin film. The inductor coil may be mounted on a substrate. The substrate may comprise a PCB.

The base portion may extend into the inductor coil. The base portion may extend through the inductor coil.

The base portion is between the inductor coil and the heating portion.

The heating portion and the base portion are non-separable. The heating portion and the base portion may be integrally formed.

As used herein, the term ‘integrally formed’ is intended to mean that the features are not separable. The features may be formed as a one piece component. That is features are formed together such that no joints are defined therebetween.

The heating portion and base portion may be thermally conductively connected between. As used herein, the term ‘conductively connected between’ does not necessarily mean that two features are directly connected between, and such an arrangement may include one or further features therebetween. The heating portion and base portion may be thermally directly conductively connected therebetween. The heating portion and base portion may be thermally indirectly conductively connected therebetween, for example by an intermediate member. As used herein, the term ‘conductively connected between’ is intended to mean the primary means of heat transfer between the heating portion and base portion.

The heating portion may comprise a first material and the at least part of the base portion may comprise a second material.

The thermal conductivity value of the first material may be greater than the thermal conductivity value of the second material.

The first material may have a lower susceptibility to being heated by penetration with the varying magnetic field than the susceptibility of the second material.

The first material may be a non-ferrous material. The second material may be one of a ferromagnetic and paramagnetic material.

The base portion may comprise a collar.

The collar may be disposed between the inductor coil and the heating portion.

The base portion may comprise a core. The collar may at least partially encircle the core.

The core and the collar may be non-separable. The collar and core may be integrally formed. The core and the heating portion may form a one piece component.

The collar may comprise an axially extending section. The collar may comprise a radially extending section. The core may be tubular. The axially extending section may be tubular.

The collar may comprise a plate.

The support section may upstand from the plate. The heating portion may be supported by the support section. The support portion may define a bore. The support portion may be a flange.

The core may extend into the collar. The core may extend through the collar.

The heating portion may protrude in the heating zone. The base portion may be spaced from the heating zone.

The heating element may be elongate and define a longitudinal axis. A radial width of the base portion may be greater than the radial width of the heating portion.

The heating element may be elongate and define a longitudinal axis. The radial width of the core may be greater than the radial width of the heating portion.

The base portion may comprise a radially extending section.

The radially extending section may comprise a flange. The flange may extend circumferentially.

The radially extending section may at least partially overlap the inductor coil.

The base portion may comprise an axially extending section extending through the inductor coil.

The radially extending section may be between the heating portion and the axially extending section of the base portion.

The base portion may comprises a chamber.

The base portion may be at least partially tubular.

The base portion may have a closed end. The closed end may be between a tubular section of the base portion and the heating portion. The heating portion may protrude from the closed end.

The apparatus may comprise an end wall defining a closed end of the heating cavity. The base portion may be external to the heating zone. The base portion may extend through the end wall.

The heating portion and the inductor coil may be offset in an axial direction. The heating zone and the base portion may be offset in an axial direction. The base portion may be external to the heating zone.

The heating element may be removable from the heating zone. The heating element may be interchangeable.

The apparatus may comprise a receptacle defining the heating zone.

The receptacle may have a base defining an end of the heating zone. The receptacle may have a peripheral wall upstanding from the base.

The heating portion may upstand from the base. The heating portion may protrude in the heating zone. The heating portion may comprise a sharp edge or point at a free end. The heating portion may be a pin or blade. The heating portion may be configured to extend into the article received by the heating region.

The heating portion and base portion may be co-axial. The heating portion and collar may be co-axial.

According to an aspect, there is provided an apparatus for heating aerosolizable material to volatize at least one component of the aerosolizable material, the apparatus comprising: a heating zone for receiving at least a portion of an article comprising aerosolizable material;

a heating assembly comprising: a magnetic field generator including a inductor coil configured to generate a varying magnetic field; a heating element comprising a heating portion and a base portion; wherein the base portion is heatable by penetration with the varying magnetic field and the heating portion protrudes from the base portion to heat the heating zone, wherein the heating portion defines an axis, wherein the base portion has a greater radial width than the heating portion and at least partially extends into the inductor coil.

The base portion may extend through an upper extent defined by the inductor coil. The base portion may extend into and/or through an aperture defined by the inductor coil. The inductor coil may be supported by a substrate. The base portion may extend through an opening defined by the substrate.

The inductor coil may be at least one of a planar coil and a spiral coil.

The spiral coil may be a flat spiral coil.

The spiral coil may be non-planar.

The apparatus of this aspect can include one or more, or all, of the features described above, as appropriate.

According to an aspect, there is provided an elongate heating element for use in apparatus for heating aerosolizable material to volatilize at least one component of the aerosolizable material, wherein the elongate heating element comprises a base portion, a heating portion and a radially extending flange between the base portion and the heating portion.

According to an aspect, there is provided an elongate heating element for use in apparatus for heating aerosolizable material to volatilize at least one component of the aerosolizable material, wherein the elongate heating element comprises a base portion and a heating portion, wherein the heating portion is heatable by the base portion by thermal conduction; and wherein the thermal conductivity of the heating portion is greater than the thermal conductivity of at least part of the base portion.

According to an aspect, there is provided an elongate heating element for use in apparatus for heating aerosolizable material to volatilize at least one component of the aerosolizable material, wherein the elongate heating element comprises an elongate heating portion defining a longitudinal axis, and a base portion extending from the elongate heating portion, wherein the base portion is tubular and has a width perpendicular to the longitudinal axis greater than the width of the heating portion.

According to an aspect, there is provided an aerosol provision device comprising at least one of the apparatus as set out above.

According to an aspect, there is provided an aerosol provision device comprising at least one of the elongate heating elements as set out above.

According to an aspect, there is provided an aerosol provision device comprising at least one of the apparatus as set out above and at least one of the elongate heating elements as set out above.

The article may be a consumable.

The aerosol provision device may be a non-combustible aerosol provision device.

The device may be a tobacco heating device, also known as a heat-not-burn device.

According to an aspect, there is provided an aerosol provision system comprising an aerosol provision device described above, and an article comprising aerosol generating material.

The aerosol generating material may be non-liquid aerosol generating material.

The article may be dimensioned to be at least partially received within the heating region.

### BRIEF DESCRIPTION OF THE DRAWINGS

Embodiments will now be described, by way of example only, and with reference to the accompanying drawings in which:

FIG. 1 shows a front perspective view of an aerosol provision device.

FIG. 2 shows schematically the aerosol provision device of FIG. 1.

FIG. 3 shows a schematic plan view of part of a magnetic field generator of the aerosol provision device of FIG. 2.

FIG. 4 shows schematically a perspective view of a heating assembly of an aerosol provision device.

FIG. 5 shows schematically a side view of the heating assembly of FIG. 4.

FIG. 6 shows schematically a cross-sectional side view of the heating assembly of FIG. 4.

FIG. 7 shows schematically a perspective view of another heating assembly of an aerosol provision device.

FIG. 8 shows schematically a side view of the heating assembly of FIG. 7.

FIG. 9 shows schematically a cross-sectional side view of the heating assembly of FIG. 7.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

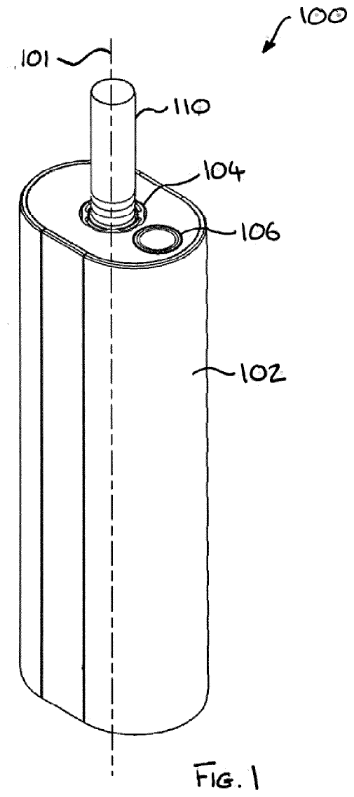

FIG. 1 shows an example of an aerosol provision device 100 for generating aerosol from an aerosol generating medium/material. The device 100 can be used to heat a replaceable article 110 comprising the aerosol generating medium, to generate an aerosol or other inhalable medium which can be inhaled by a user of the device 100.

The device 100 comprises a housing 102 which surrounds and houses various components of the device 100. The device 100 has an opening 104 in one end, through which the article 110 can be inserted for heating by the device 100. The article 110 may be fully or partially inserted into the device 100 for heating by the device 100.

The device 100 may comprise a user-operable control element 106, such as a button or switch, which operates the device 100 when operated, e.g. pressed. For example, a user may activate the device 100 by pressing the switch 106.

The device 100 defines a longitudinal axis 101, along which an article 110 may extend when inserted into the device 100.

FIG. 2 is a schematic illustration of the aerosol provision device 100 of FIG. 1, showing various components of the device 100. It will be appreciated that the device 100 may include other components not shown in FIG. 2.

As shown in FIG. 2, the device 100 includes an apparatus for heating aerosolizable material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol generating medium of an article 110 inserted into the device 100, such that an aerosol is generated from the aerosol generating medium. The power source 204 supplies electrical power to the heating assembly 201, and the heating assembly 201 converts the supplied electrical energy into heat energy for heating the aerosol generating medium.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The battery 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 100 closest to the opening 104 may be known as the proximal end (or mouth end) 107 of the device 100 because, in use, it is closest to the mouth of the user. In use, a user inserts an article 110 into the opening 104, operates the user control 106 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end 108 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214.

The heating chamber 211 is defined by the inner walls of the receptacle 212. The receptacle 212 acts as a support member. The receptacle comprises a generally tubular member extending along and around and substantially coaxial with the longitudinal axis 101 of the device 100. However, other shapes would be possible. The receptacle 212 (and so heating chamber 211) is open at its proximal end such that an article 110 inserted into the opening 104 of the device 100 can be received by the heating chamber 211 therethrough. The receptacle 212 is closed at its distal end by the end wall 213. The receptacle 212 may comprise one or more conduits that form an air passage. In use, the distal end of the article 110 may be positioned in proximity or engagement with the end of the heating chamber 211. Air may pass through the one or more conduits, into the heating chamber 211, and flow through the article 110 towards the proximal end of the device 100.

The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 100. The receptacle 212 may be formed from a rigid material to aid support of other components.

Other arrangements for the receptacle 212 would be possible. For example, in an embodiment the end wall 213 is defined by part of the heating assembly 201.

As illustrated in FIG. 2, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating element 220 is heatable to heat the heating zone 215. The heating element 220 is an induction heating element. That is, the heating element 220 comprises a susceptor that is heatable by penetration with a varying magnetic field. The heating element 220 comprises a heating portion 221 and a base portion 222. The base portion 222 acts as the susceptor.

The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the susceptor so as to cause heating in the susceptor. The magnetic field generator 240 includes an inductor coil 241, acting as an inductor element. The inductor coil 241 is on a printed circuit board (PCB) 250 acting as a substrate, however other arrangements are envisaged.

The heating element 220 extends in the heating zone 215. The heating portion 221, acting as a protruding element, protrudes in the heating zone 215. The heating element 220 is spaced from the peripheral wall 214. The heating assembly 201 is configured such that when an article 110 is received by the heating chamber 211, the heating portion 221 of the heating element 220 extends into a distal end of the article 110. The heating portion 221 of the heating element 220 is positioned, in use, within the article 110. The heating element 220 is configured to heat aerosol generating material of an article 110 from within, and for this reason is referred to as an inner heating element. To facilitate this, the inner heating element 220 is configured to pierce an article 110 that is inserted into the device 100.

In the present embodiment, the heating portion 221 of the heating element 220 comprises a sharp edge or point at its proximal end 223. The heating portion 221 is a pin. Other shapes are envisaged, for example the heating portion 221 in embodiments is a blade. The heating portion 221 may extend into the heating chamber 211 from the distal end of the heating chamber 211 along the longitudinal axis 101 of the device (in the axial direction). In embodiments the heating portion 221 extends into the heating chamber 211 spaced from the axis 101. The heating portion 211 may be off-axis or non-parallel to the axis 101. Although one heating portion 221 of the heating element 220 is shown, it will be understood that in embodiments, the heating element 220 comprises a plurality of heating portions 221. Such heating portions in embodiments are spaced from but parallel to each other.

The heating element 220 extends from the heating zone 215. The heating element 220 extends external to the heating zone 220. The heating element 220 is received through the receptacle 212. The base portion 222 extends through the end wall 213. The inductor coil 241 is disposed external to the receptacle 212. The inductor coil 241 is disposed adjacent to the end wall 213. In embodiments, the inductor coil 241 is mounted to the end wall 213. In embodiments the inductor coil 241 is spaced from the end wall 213. The end wall 213 may form the substrate supporting the inductor coil 241. Base portion 222 is shown external to the heating chamber 211 in FIG. 2. In embodiments, a portion of the base portion 222 extends in the heating chamber 211. In an embodiment, the base portion 222 defines at least part of the closed end of the heating chamber 211.

The base portion 222 of the heating element 220 extends into the inductor coil 241. That is, the inductor coil 241 defines an inductor zone 241. The inductor zone 241 is a space defined by the inductor coil 241 in which a feature is receivable to be heatable by penetration with a varying magnetic field generated by the inductor coil 241. In the present embodiment, the inductor zone 241 is partially defined by an aperture.

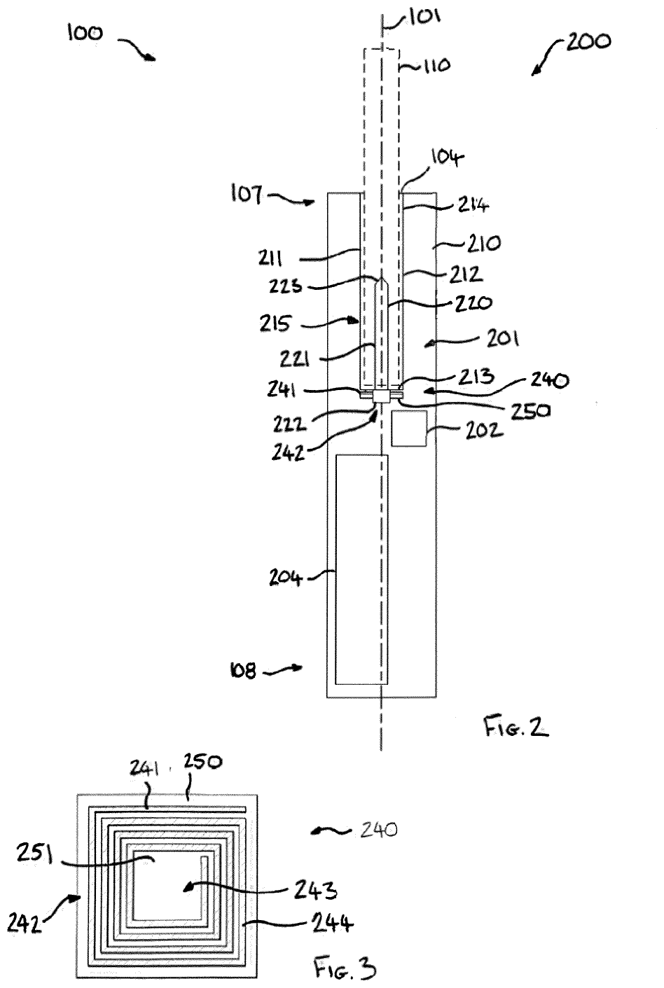

The inductor coil 241 is shown in FIG. 3. The inductor coil 241 is a two-dimensional spiral on a surface of the PCB 250. The PCB 250 acts as a substrate. The substrate supports the coil 241. The inductor coil 241 is defined by a film. In this embodiment, the substrate 250 is a non-electrically conductive support. That is, the substrate is an electrical insulator. In other embodiments, the support substrate may be omitted.

In the present embodiment, the inductor coil 241 is deposited on a flat substrate or support. The inductor coil 241 in embodiments has a three-dimensional shape, for example, the inductor coil 241 may define a recess.

The inductor coil 241 is an electrically conductive coil configured to conduct a varying electrical current. The coil may be formed, for example, by depositing, printing, etching, chemically or mechanically bonding.

As shown in FIG. 3, the inductor coil 241 is a generally square or rectangular coil. In other embodiments, the inductor coil 241 may have a different shape, such as generally circular or elliptical. In some embodiments, the inductor coil 241 may be a three-dimensional spiral. In some such embodiments, the inductor coil 241 may be manufactured using an additive manufacturing technique, such as 3D printing. In this embodiment, adjacent spaced portions of the inductor coil 241 are regularly spaced. In other embodiments, such portions of the inductor coil 241 may not be regularly spaced.

An aperture 243 is defined by the inductor coil 241. In the present arrangement the aperture 243 is defined in the axial center of the inductor coil 241. The aperture 243 is configured to receive the base portion 222 therein. The aperture 243 extends from a proximal extent 244 of the inductor coil 241. The aperture 241 is defined by the innermost side of the inductor coil 241. The aperture corresponds to the shape of the inductor coil 241. The aperture 243 is coaxial with the axis 101. In embodiments in which the heating element 220 is offset from the axis, the aperture is offset.

An opening 251 is formed in the substrate 250. The opening 251 is aligned with the aperture 243. The opening 251 is configured to receive the base portion 222 therein. In an embodiment is which the base portion 222 extends through the inductor coil 241, the base portion 222 extends at least into the opening 251. The opening 251 and the substrate 250 may be omitted.

Where the base portion 222 extends through the inductor coil 241 the base portion 222 is susceptible to varying magnetic flux on both a proximal side and a distal side of the inductor coil 241. The base portion may therefore be susceptible to varying magnetic flux on both sides of the inductor coil 241.

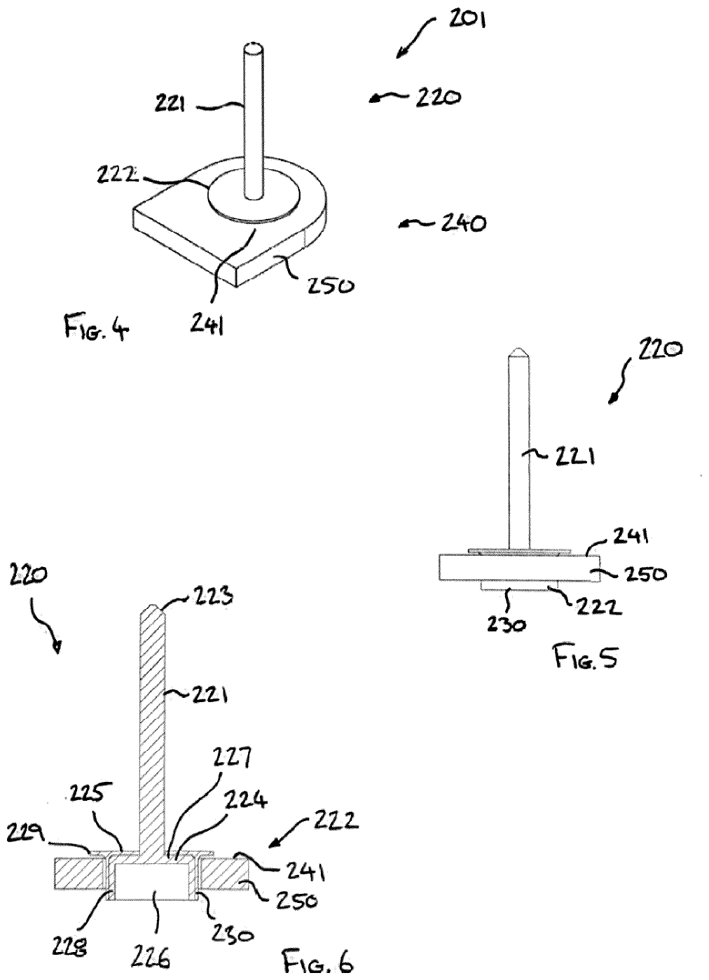

FIGS. 4, 5 and 6 are schematic illustrations of an embodiment of the heating assembly 201 in more detail. It will be appreciated that the heating assembly 201 may include other components not shown in FIGS. 4 to 6.

As shown in FIGS. 4 to 6, the heating assembly 201 comprises the heating element 220 and the magnetic field generator 240. The inductor coil 241 of the magnetic field generator 240 is shown in the FIGS. 4 to 6.

The heating element 220 comprises the base portion 222 with the heating portion 221 protruding from the base portion 222. The heating portion 221 is heatable by the base portion 222 by thermal conduction. The heating portion 221 and base portion 222 are thermally conductively connected. The base portion 222 has a greater radial extent than the heating portion 221. The base portion 222 is generally cylindrical, however other shapes are anticipated.

The elongate heating portion 221 extends from the base portion 222 at its distal end. The elongate heating portion 221 and the base portion 222 are coaxial. The base portion 222 has an axial height. The axial height of the base portion 222 is greater than the depth of the inductor coil 241. When assembled the base portion 222 extends on the proximal side and the distal side of the inductor coil 241. The base portion 222 extends through the inductor coil 241. Such an arrangement aids to maximize the magnetic flux intersecting with the base portion 222.

The base portion 222 is generally cylindrical. The base portion 222 defines a chamber 226. That is the base portion 222 is at least partially hollow. By providing a chamber 226 in the base portion 222 helps to minimize the mass of material to be heated, and so aids with thermal concentration. The chamber 226 helps to minimize the thermal load of material in a region which could draw heat away from the elongate heating portion 221. The base portion 222 comprises a tubular arrangement. The chamber 226 may be omitted.

The base portion 222 has a closed end 227. The heating portion 221 upstands from the closed end 227. The closed end 227 is planar, although other shapes are anticipated. The closed end 227 is disposed between the tubular section of the base portion 222 and the heating portion 221.

The tubular section of the base portion 222 defines an axially extending flange 228. The axially extending flange 228 extends parallel with the longitudinal axis 101. The axially extending flange 228 extends coaxially. Accordingly the axially extending flange 228 extends through the inductor coil 241. The axially extending flange 228 overlaps the inductor coil 241 in the axial direction.

The base portion 222 comprises a radially extending flange 229. The radially extending flange 229 extends circumferentially. The radially extending flange overlaps the inductor coil 241 in the radial direction. With such an arrangement, the base portion 222, acting as the susceptor overlaps the inductor coil in both radial and axial directions.

The base portion 222 comprises a core 224 and a collar 225. The core 224 is an extension of the heating portion 221. The core 224 is integrally formed with the heating portion as a one piece component. The core 224 in the present embodiment is a radially wider portion than the heating portion 221. In embodiments the core 224 has a corresponding radial width to the heating portion 221. The core 224 is an extension of the heating portion 221. By forming the core 224 and the heating portion 221 together it is possible to aid heat conduction along the heating element. The core 224 is conductively connected to the collar 225. Accordingly, heat transfer from the collar 225 to the core 224 occurs by conduction when the collar 225 is heated. The collar 225 forms an interference fit with the core 224. The collar 225 may be connected to the core 224 by different means.

The collar 225 encircles the core 224. In embodiments the collar 225 partially encircles the core 224. In the present embodiment the collar 225 encloses an upper side of the core 224. The collar 225 defines an outer layer of the core 224. The heating portion 221 protrudes through the collar 225. The collar 225 comprises an axial section 230 encircling the peripheral side of the core 224. This provides an greater surface contact region between the features. Accordingly, thermal transfer may be maximized. The collar 225 in the present embodiment forms the radially extending flange 229. Accordingly, the collar 225 overlaps the inductor coil 241 in both axial and radial directions. With such an arrangement, the collar 225 is able to intersect a greater number of magnetic flux lines.

The heating portion 221 has a thermal conductivity greater than the thermal conductivity of the collar 225. The collar 225 is formed from a different material. The base portion 222 and the heating element 220 have different thermally conductive properties. The collar 225 acts as the susceptor, and is formed from a material susceptible to being heated by penetration with the varying magnetic field. The collar 225 comprises electrically conducting material suitable for heating by electromagnetic induction. For example, the susceptor may be formed from a carbon steel. It will be understood that other suitable materials may be used, for example a ferromagnetic material such as iron, nickel or cobalt.

The core 224 has a thermal conductivity greater than the thermal conductivity of the collar 225. The core 224 is formed from a material having a high thermal conductivity, for example one or more of copper, aluminum and austenitic nickel chromium.

The material of the heating portion 221 has a lower susceptibility to being heated by penetration with the varying magnetic field than the susceptibility of the collar 225. The material forming the collar 225 has a higher susceptibility to being heated by penetration with the varying magnetic field than the susceptibility of the heating portion 221. The material of the heating portion 221 is a non-ferrous material. The material of the collar 225 is one of a ferromagnetic and paramagnetic material.

The high thermal conductivity of the heating portion 221 aids heat transfer. Accordingly, when the collar 225 is heated, the thermal transfer of heat along the heating portion 221 is maximized. This aids a more uniform heating of the elongate heating member along the axial length.

Although as described above the base portion comprises a base portion with a core and a collar, in embodiments, the base portion defines the susceptor without a core portion extending in the susceptor. In another embodiment the core is an extension of the heating portion having constant cross-sectional profile along the length between the heating portion and the core as described below.

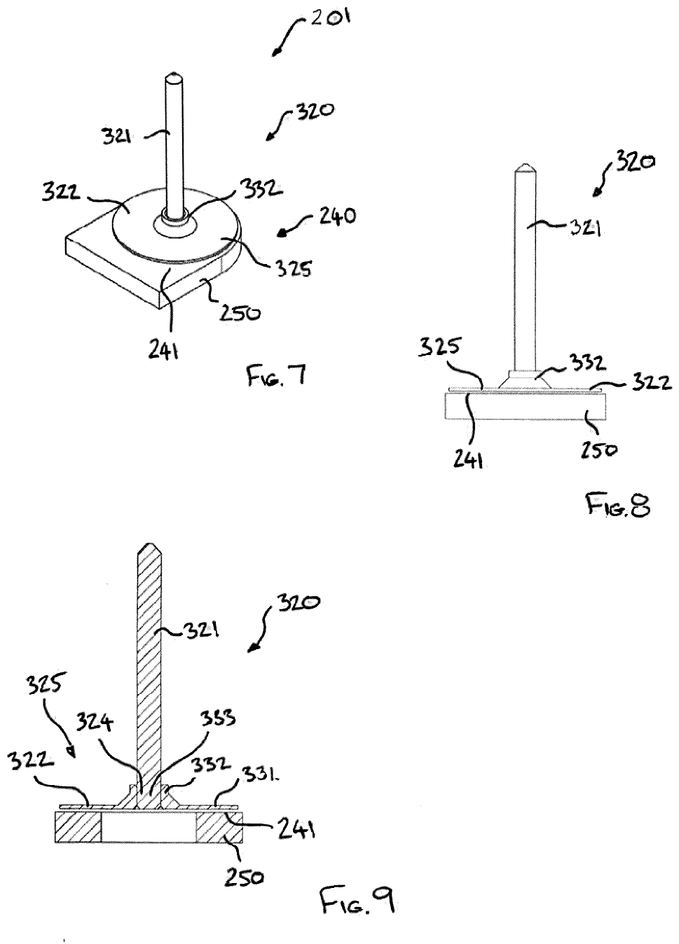

FIGS. 7, 8 and 9 are schematic illustrations of an embodiment of the heating assembly 201 in more detail. It will be appreciated that the heating assembly 201 may include other components not shown in FIGS. 7 to 9. The configuration of the device 100 is generally as described above and so a detailed description will be omitted. As described below the arrangement of the heating element differs.

As shown in FIGS. 7 to 9, the heating assembly 201 comprises a heating element 320 and the magnetic field generator 240. The inductor coil 241 of the magnetic field generator 240 is shown in the FIGS. 7 to 9.

The heating element 320 comprises a base portion 322 with the heating portion 321 protruding from the base portion 322. The heating portion 321 is heatable by the base portion 322 by thermal conduction. The heating portion 321 and base portion 322 are thermally conductively connected. The base portion 322 has a greater radial extent than the heating portion 321. The base portion 322 is generally circular, however other shapes are anticipated.

The base portion 322 comprises a plate 331 and a support portion 332. The support section 332 upstands from the plate 331. The support section 332 upstands on the proximal side of the plate 331. In embodiments, the support section upstands on the distal side. In embodiments, the support section 332 upstands from both sides of the support section 332. The support section 332 supports the heating portion 321. The support section comprises a bore 333. The bore 333 extends through the plate 331. The bore 333 in embodiments is a closed bore.

The elongate heating portion 321 upstands from the base portion 322. A core 324 is received in the bore 333. The core 224 is an extension of the heating portion 321. The core 324 is integrally formed with the heating portion as a one piece component. The core 324 in the present embodiment has a uniform cross-sectional profile with the heating portion 321. That is, the core 324 has a corresponding radial width to the heating portion 321. The core 324 is an extension of the heating portion 321. By forming the core 324 and the heating portion 321 together it is possible to aid heat conduction along the heating element. The core 324 is conductively connected to the collar 325. Accordingly, heat transfer from the collar 325 to the core 324 occurs by conduction when the collar 325 is heated. The collar 325 forms an interference fit with the core 324. The collar 325 may be connected to the core 324 by different means. The collar 325 encircles the core 324. In embodiments the collar 325 partially encircles the core 324.

The heating portion 321 has a thermal conductivity greater than the thermal conductivity of the collar 325. The collar 325 is formed from a different material. The base portion 322 and the heating element 320 have different thermally conductive properties. The collar 325 acts as the susceptor, and is formed from a material susceptible to being heated by penetration with the varying magnetic field. The collar 325 comprises electrically conducting material suitable for heating by electromagnetic induction. For example, the susceptor may be formed from a carbon steel. It will be understood that other suitable materials may be used, for example a ferromagnetic material such as iron, nickel or cobalt.

The core 324 has a thermal conductivity greater than the thermal conductivity of the collar 325. The core 324 is formed from a material having a high thermal conductivity, for example copper, aluminum, and austenitic nickel chromium.

The material of the heating portion 321 has a lower susceptibility to being heated by penetration with the varying magnetic field than the susceptibility of the collar 325. The material forming the collar 325 has a higher susceptibility to being heated by penetration with the varying magnetic field than the susceptibility of the heating portion 321. The material of the heating portion 321 is a non-ferrous material. The material of the collar 325 is one of a ferromagnetic and paramagnetic material.

The high thermal conductivity of the heating portion 321 aids heat transfer. Accordingly, when the collar 325 is heated, the thermal transfer of heat along the heating portion 321 is maximized. This aids a more uniform heating of the elongate heating member along the axial length.

In the shown embodiments the distal end of the heating portion 321 is surrounded by the base portion of the heating element. In other words, some of the base portion overlaps some but not all of the axial length of the heating portion in the axial direction. Such an arrangement provides for conductive heating of the heating portion by the base portion, and conductive heating of the article by the heating portion.

The majority of the base portion may not surround the heating portion. That is, the majority of the axial height of the base portion may not overlap the heating portion in the axial direction. For example, between 5% and 20%, or between 10% and 15% of the axial length of the base portion may overlap the heating portion in the axial direction.

In the above described embodiments, the inductor coil 241, 341 is a flat spiral coil. Other arrangements of inductor coil are envisaged. In embodiments, the inductor coil comprises at least one of a conical arrangement, an arcuate arrangement and a helical arrangement. For example, in the arrangement shown in FIGS. 4 to 6, as well as other arrangements, the inductor coil comprises a helical coil. Such a helical coil extends outside of the heating chamber. The helical coil is outside of the heating zone.

In each arrangement the inductor coil is configured to generate a varying magnetic field that penetrates the base portion, acting as a susceptor, to cause heating of the base portion, and therefore indirect conductive heating of the heating portion.

In the above described embodiments, the inductor coil is formed as an electrically conductive film. Other arrangements are envisaged. For example, the inductor coil may be formed as a wire. The inductor coil may be a helical or spiral coil comprising electrically-conductive material, such as copper. The coil may be formed from wire, such as Litz wire, which is wound helically or in a spiral around or on a support member. Litz wire comprises a plurality of individual wires which are individually insulated and are twisted together to form a single wire. Litz wires are designed to reduce the skin effect losses in a conductor. Other wire types could be used, such as solid.

With a helical inductor coil arrangement, the inductor coil may extend around, and be supported by, a support member (not shown). The inductor coil may be arranged coaxially with the support member and heating chamber (and longitudinal axis 101). The helical inductor coil may define a bore in which the base portion extends into. The base portion may extend through the bore.

In the above described embodiments the base portion is at least partially disposed between the inductor coil and the heating zone. Accordingly the base portion acts as a barrier to limit the varying magnetic field exposure to the heating zone, and components around the heating zone. Such an arrangement may limit heating caused to any susceptor material introduced into the heating chamber.

By providing a heating portion having a thermal conductivity greater than the thermal conductivity of at least part of the base portion it is possible to aid an optimized design of the base portion without concern for ensuring that the heating element is exposed to a varying magnetic field.

In embodiments, the heating portion of the heating element is separable from the base portion. For example, in the embodiments described with reference to FIGS. 7 to 9, the plate forming the base portion may be fixedly mounted in the receptacle with the elongate heating element being separable from the base portion. The base portion may be define part or the whole of the end wall. The base portion may be integrally formed with the receptacle.

In configurations with a separable base portion and heating element, the collar acts as a support member to support the heating element. The collar may also act as a retention member, for example by an interference fit.

In embodiments, the heating element is removable from the remainder of the device. The heating element is able to be withdrawn from the heating zone. In such an arrangement the heating element is able to be detached from the receptacle. When the heating element is withdrawn from the heating zone the heating element is withdrawn from the inductor zone. The base portion is withdrawn from the inductor zone. An attachment arrangement may releasably attach the heating element in the remainder of the device. In embodiments a push fit or interference fit may be used. In embodiments another attachment arrangement may be utilized such as a bayonet arrangement. By providing a removable heating element the heating element may be interchangeable.

The provision of the base portion with a greater radial width than the heating portion may aid with securely mounting the heating element in the heating zone. Such an arrangement may benefit the stability of the heating element by providing a wider base.

In embodiments, the heating element is fixedly connected to the device 100 such that it extends within the heating zone at a fixed position with respect to the inductor coil. In these embodiments, the heating element extends into an article 110 when the article 110 is received by the heating zone. In other embodiments, however, the heating element may be provided within an article 110 that is to be inserted into the device 100. In these embodiments, the heating element may be moveable with respect to the inductor coil. In these embodiments, the heating element may extend within the heating zone when the article 110 is received by the heating zone.

In the above described embodiments the heating portion is an inner susceptor. That is, the heating portion protrudes into the heating chamber and is arranged to be received by the article. In another embodiment the heating portion is an outer susceptor. In such a configuration, the heating member may be a generally tubular member extending along and substantially coaxial with the longitudinal axis 101. The heating member may extend at least partially around an axial portion of the heating chamber. The heating member may extend continuously around the entire circumference of the heating chamber, or only partially extend around the chamber. For example, one or more discontinuities, e.g. holes, gaps or slots, may be provided in the heating member. The heating member may be configured and dimensioned to extend around an article received by the heating chamber. The heating member may thus be positioned, in use, around an article. The heating member may thus be configured to heat aerosol generating material of the article 110 from outside, and for this reason be referred to as an outer heating element. The heating member may have a circular cross section, e.g. corresponding a circular cross section of the article 110. Other cross sectional shapes would be possible.

The heating member may extend along the heating region for any suitable distance. The heating member in such an embodiment may form the receptacle. The base portion is disposed at an end of the tubular member. The outer heating member may form the tubular member at one end. The base portion in such embodiments may extend one or both of axially or radially inwardly. The base portion may define the end wall. The base collar in some embodiments is a collar around the tubular member.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for heating aerosolizable material to volatize at least one component of the aerosolizable material, the apparatus comprising:
a heating zone for receiving at least a portion of an article comprising aerosolizable material; and
a heating assembly comprising:
a magnetic field generator including an inductor coil configured to generate a varying magnetic field, and
a heating element comprising a base portion that is heatable by penetration with the varying magnetic field and a heating portion protruding from the base portion to heat the heating zone,
wherein the heating portion is heatable by the base portion by thermal conduction, and wherein a thermal conductivity of the heating portion is greater than a thermal conductivity of at least part of the base portion.

2. The apparatus of claim 1, wherein the inductor coil is at least one of a planar coil or a spiral coil.

3. The apparatus of claim 1, wherein the base portion extends through the inductor coil.

4. The apparatus of claim 1, wherein the base portion is between the inductor coil and the heating portion.

5. The apparatus of claim 1, wherein the heating portion comprises a first material and the at least part of the base portion comprises a second material.

6. The apparatus of claim 5, wherein a thermal conductivity value of the first material is greater than a thermal conductivity value of the second material.

7. The apparatus of claim 5, wherein the first material has a lower susceptibility to being heated by penetration with the varying magnetic field than a susceptibility of the second material.

8. The apparatus of claim 1, wherein the base portion comprises a collar.

9. The apparatus of claim 8, wherein the base portion comprises a core and the collar at least partially encircling the core.

10. (canceled)

11. The apparatus of claim 8, wherein the collar comprises an axially extending section and a radially extending section.

12. The apparatus of claim 8, wherein the collar comprises a plate.

13. The apparatus of claim 1, wherein the heating element is elongate and defines a longitudinal axis, and a radial width of the base portion is greater than a radial width of the heating portion.

14. The apparatus of claim 1, wherein the base portion comprises a radially extending section.

15. (canceled)

16. The apparatus of claim 14, wherein the base portion comprises an axially extending section extending through the inductor coil.

17. The apparatus of claim 16, wherein the radially extending section is between the heating portion and the axially extending section of the base portion.

18. The apparatus of claim 1, wherein the base portion comprises a chamber.

19. An apparatus for heating aerosolizable material to volatize at least one component of the aerosolizable material, the apparatus comprising:
a heating zone for receiving at least a portion of an article comprising aerosolizable material; and
a heating assembly comprising:
a magnetic field generator including a inductor coil configured to generate a varying magnetic field, and
a heating element comprising a heating portion and a base portion,
wherein the base portion is heatable by penetration with the varying magnetic field and the heating portion protrudes from the base portion to heat the heating zone, wherein the heating portion defines an axis, and wherein the base portion has a greater radial width than the heating portion and at least partially extends into the inductor coil.

20. An elongate heating element for use in an apparatus for heating aerosolizable material to volatilize at least one component of the aerosolizable material, wherein the elongate heating element comprises:
a base portion;
a heating portion; and
a radially extending flange between the base portion and the heating portion.

21. An elongate heating element for use in an apparatus for heating aerosolizable material to volatilize at least one component of the aerosolizable material, wherein the elongate heating element comprises:
a base portion; and
a heating portion,
wherein the heating portion is heatable by the base portion by thermal conduction, and wherein a thermal conductivity of the heating portion is greater than a thermal conductivity of at least part of the base portion.

22. (canceled)

23. (canceled)

24. An aerosol provision system comprising the apparatus of claim 1, and an article comprising aerosol generating material.

25. (canceled)
